(19) United States
(12) Patent Application Publication
(10) Pub. No.: US 2026/0030883 A1
(43) Pub. Date: Jan. 29, 2026

(54) MACHINE LEARNING BASED BOREHOLE DATA ANALYSIS

(71) Applicant: CGG SERVICES SAS, Massy Cedex (FR)

(72) Inventors: Song HOU, Horsham (GB); Edward JARVIS, Abergwyngregyn, Llanfairfechan (GB); Haoyi WANG, Crawley (GB); Jonathan DIETZ, Glasgow (GB)

(21) Appl. No.: 18/995,390

(22) PCT Filed: Jun. 26, 2023
(86) PCT No.: PCT/IB2023/000380

§ 371 Date: Jan. 16, 2025

Related U.S. Application Data
(60) Provisional application No. 63/391,486, filed on Jul. 22, 2022.
(60) Provisional application No. 63/391,716, filed on Jul. 23, 2022.
(60) Provisional application No. 63/479,268, filed on Jan. 10, 2023.

(51) Int. Cl. G06V 20/10; G06V 10/26; G06V 10/44; G06V 10/72; G06V 10/764; G06V 10/77; G06V 10/82

(52) U.S. Cl. CPC G06V 20/176; G06V 10/267; G06V 10/273; G06V 10/44; G06V 10/72; G06V 10/764; G06V 10/7715; G06V 10/82

(57) ABSTRACT

A method for autopicking of bedding in a well includes receiving image logs associated with the well, eliminating tool marks from the image logs, performing a grid search for (1) a vertical amplitude and (2) a horizontal shift of the bedding at plural sampling depths to obtain a predicted bedding, calculating an azimuth and a dip of the predicted bedding, and generating an image of the predicted bedding, wherein the image includes structural features of the well.

### BACKGROUND OF THE INVENTION

### Technical Field

Embodiments of the subject matter disclosed herein generally relate to

a system and method for analyzing geophysical data, and more particularly, to machine learning methods for analyzing well related data for reducing human interpreter bias, decreasing interpretation time, and/or generating an integrated dataset.

### Discussion of the Background

During oil and gas exploration, a seismic survey is initially performed to determine the location of the oil reservoir, and then one or more wells are drilled to reach the reservoir and extract the oil. During drilling, core and side wall core samples are collected. They can provide valuable insights into the subsurface's structure. They are often the only sample types which provide a physical sample of the subsurface rock. These samples are routinely photographed, and thin section photomicrographs are prepared. When integrated with borehole image logs, these data types provide subsurface context from a micro level scale (e.g., pixel scale) to well scale.

Seismic data obtained during the seismic surveys provide measurements of travel times of seismic waves from the source to various receivers. Seismic data processing is a type of inverse problem, that is, a model of the underground formation probed when seismic data was acquired is developed and perfected so that simulated data generated using the model and physical laws to match the seismic data as close as possible. The model is a three-dimensional (3D) image of the underground formation with “pixels colored” by various properties values throughout the underground formation's volume. The inversion results are usually not unique (i.e., more than one model may adequately fit the data) and may be sensitive to relatively small errors in data collection, processing, or analysis. For these reasons, integrating additional information, such as petrophysical well logs, provide a valuable tool for enhancing the outcome of seismic data processing.

Thus, the core and side wall samples together with the borehole image logs can be used in a variety of applications for enhancing the oil exploration methodologies. Typically, however, the interpretation of each of these data types is slow, often subjective, and expensive, resulting in underutilized resources. For example, the current techniques for interpreting image logs (picking of bedding, identifying breakout regions and generating facies intervals) are at present all labour intensive as they are manual processes. Generating a bedding pick typically involves identifying the feature of interest in the image log and manually assigning a sine wave to it as well as classifying that pick. This is done by the interpreter, over the entire imaged interval, often covering hundreds of metres. Hundreds to thousands of picks are generated per image log, all manually, taking days to generate.

Automated solutions that currently exist are inaccurate and are time consuming to run, often requiring a large degree of manual intervention and supervision. Manually interpreting breakout regions is a similar process to picking bedding, where the interpreter identifies where the breakout region is within the image log and manually draws a box around every occurrence. The interpretation of image log facies is completed after all the other picks have been made. This involves the interpreter identifying the main characteristics in each image log and assigning intervals based on these characteristics.

These manual interpretation techniques are slow, taking days to weeks to complete all these tasks for one image log. The interpretations are typically subjective and prone to interpreter bias as well as interpreter fatigue. Switching between interpreters for a project, relies on those interpreters having very similar interpretation styles, which is very difficult to achieve.

Thus, there is a need for a new methodology and system that are capable of automating the above discussed processes and avoiding as much as possible the manual and subjective interpretation of the data.

### SUMMARY OF THE INVENTION

According to an embodiment, there is a method for autopicking of bedding in a well, and the method includes receiving image logs associated with the well, eliminating tool marks from the image logs, performing a grid search for (1) a vertical amplitude and (2) a horizontal shift of the bedding at plural sampling depths to obtain a predicted bedding, calculating an azimuth and a dip of the predicted bedding, and generating an image of the predicted bedding, wherein the image includes structural features of the well.

According to another embodiment, there is a method for breakout detection in a well, and the method includes receiving image logs associated with the well, polarizing the image logs to distinguish between dark and bright pixels, applying one or more algorithms to enhance a difference between the dark and bright pixels, and generating an image with breakout regions by selecting the dark pixels, wherein the image includes structural features of the well.

According to yet another embodiment, there is a method for facies classification based on image logs associated with a log, and the method includes receiving image logs associated with the well, splitting the image logs into plural patches, implementing a trained classifier to determine the facies corresponding to the plural patches, and assembling the facies to obtain an image of the well, wherein the image includes structural features of the well.

### BRIEF DESCRIPTION OF THE DRAWINGS

For a more complete understanding of the present invention, reference is now made to the following descriptions taken in conjunction with the accompanying drawings, in which:

FIG. 1 is a flow chart of a method for breakout detection in a well based on image logs;

FIG. 2 schematically illustrates an erosion algorithm used for the breakout detection;

FIG. 3 schematically illustrates a dilation algorithm used for the breakout detection;

FIG. 4 schematically illustrates a non-maximum suppression algorithm used for the breakout detection;

FIG. 5 is a flow chart of a method for autopicking of bedding in a well;

FIGS. 6A to 6F illustrate the various stages of autopicking of bedding;

FIG. 7 schematically illustrates an autopicking algorithm used to determine the bedding in a well;

FIG. 8 is a flow chart of a method for automatically determining facies from image logs from a well;

FIGS. 9A to 9G schematically illustrate the starting images for the method of FIG. 8 and how the various steps manipulate these images to obtain a final image of the well that has the facies labeled;

FIG. 10 is a flow chart of a method for lithology prediction based on thin images of samples taken from the well;

FIG. 11 is a flow chart of a method for determining pore characteristics of a subsurface from thin section images;

FIGS. 12A and 12B show two color spaces that are used by the method of FIG. 11;

FIGS. 13A to 13C illustrate a process of noise and marks removal from thin images for detecting the pores;

FIG. 14 schematically illustrates a method for classifying microfacies from thin images; and

FIG. 15 is a schematic diagram of a computing system used to run any of the methods discussed herein.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to images and/or data taken from a well during a drilling process in search for oil. However, the embodiments to be discussed next are not limited to oil exploration, but they may be used for other applications, for example CO2 subterranean storage, ore exploration, geothermal water circulation, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

According to the following embodiments, a series of new techniques have been developed with the goal of reducing interpreter bias, decreasing interpretation times, and generating an integrated dataset for borehole interpretation workflow. These techniques enable rapid screening and prediction of lithology from core images, prediction of grain type, microfacies and generating pore property statistics from thin section photomicrographs as well as generating auto picks and facies from borehole image logs. These techniques are based on recent advancements in data science and machine learning, such as image segmentation and object classification. By applying data science techniques to traditional geoscience problems, the following embodiments were able to generate large volumes of data with quantified degrees of confidence and a reduction in interpreter bias. Automating steps in the borehole interpretation workflow removes interpreter bias from the interpretation process, generating a much less subjective interpretation result. Using data science and machine learning techniques also significantly decreases the time associated with manual interpretation. This allows the interpreter to spend valuable time on more important tasks such as Quality Control (QC) and data integration.

Novel methods related to image log data analysis are discussed followed by novel methods related to core imaging processing and thin section analysis. Note that each of the individual method discussed herein can be combine with any other method discussed herein or with a set of such methods to obtain an integrated dataset. Before discussing the details of the image log data analysis, some definitions associated with the image logs are introduced. Image log data is derived from well logging tools that capture high-resolution images of the interior surfaces of boreholes. These images provide detailed information about the geological formations and structures encountered during drilling operations. Image logs can be generated using various logging techniques, such as:

Acoustic Televiewer (ATV) logs: These tools use ultrasonic waves to create an image of the borehole wall. The tool emits ultrasonic pulses, which are reflected back by the formations around the well, and the travel time and amplitude of the reflected waves are used to generate a visual representation of the borehole wall.

Electrical Resistivity Imaging (ERI) logs: These tools measure the resistivity of the borehole wall and create an image based on the differences in resistivity. The images can provide insight into the texture, porosity, and fluid content of the rock formations.

Optical Televiewer (OTV) logs: These tools use a downhole camera to capture high-resolution images of the borehole wall using visible light. The images can be used to analyze rock structures, fractures, and mineralogy. Those skilled in the art would understand that other type of data may be used, e.g., gravity data, magnetic data, radioactive related data, etc. as logging may include acquiring measurements as to one or more of electrical properties (e.g., resistivity and conductivity at various frequencies), sonic properties, active and passive nuclear measurements, dimensional measurements of the wellbore, formation fluid sampling, formation pressure measurement, and wireline-conveyed sidewall coring tool measurements. The devices for obtaining this data is known in the art and they may be lowered into the well or placed around the well, either at the surface or in the subsurface. Thus, herein, a step of receiving image log data means receiving any one or a combination of the data noted above.

The petrophysical values associated with a well may be displayed as a colour spectrum in the image. The colour spectrum range can be set to represent the full range of the entire dataset or alternatively, can be set to represent only the data value range for a specifically set, for example, a narrower depth window (typically set at 10 m). The latter scenario is useful where detailed features may need to be defined. These data view options are defined as either static or dynamic. Image logs are valuable for understanding the geology and subsurface structure of the wellbore, and they can be used for various applications, such as identifying fractures, analyzing sedimentary structures, and determining rock and fluids.

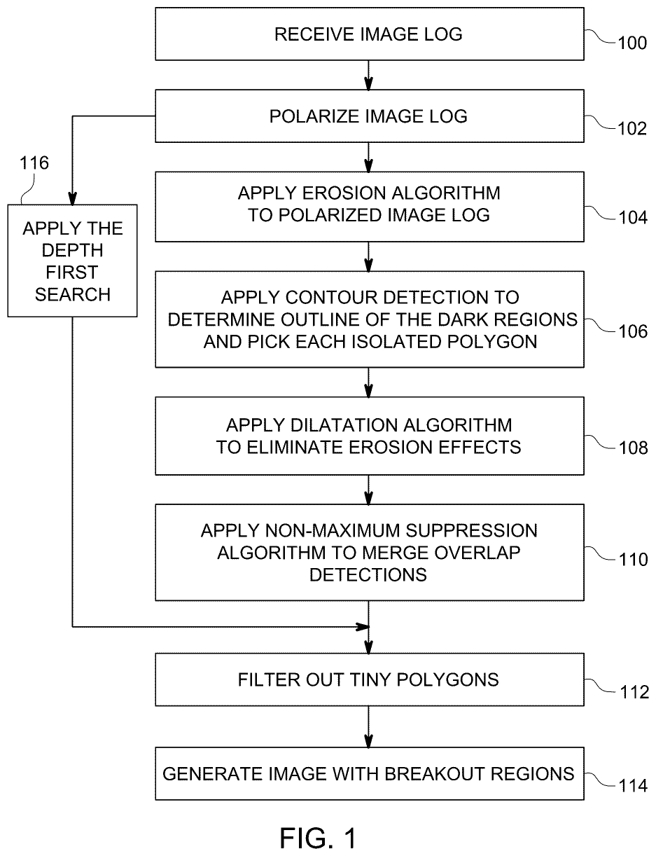

According to an embodiment, a method for breakout detection is now discussed with regard to FIG. 1. Borehole breakouts occur when the drilling process 20) causes the rock in the borehole to fail. This failure can be caused by the interaction of the drill bit with the formation, as well as by the pressure of the drilling fluid within the borehole. Breakouts are typically characterized by a semicircular or elliptical shape, with the long axis oriented perpendicular to the maximum horizontal stress in the formation. Thus, breakouts can provide valuable information about the stress field and rock properties in the formation being drilled, which can be used to optimize drilling and completion strategies. Further, it is desired to monitor for borehole breakouts during drilling operations, as they can lead to wellbore instability, lost circulation, and other drilling hazards. Detecting and analysing breakouts can help drilling engineers and geologists make informed decisions to ensure safe and efficient drilling operations.

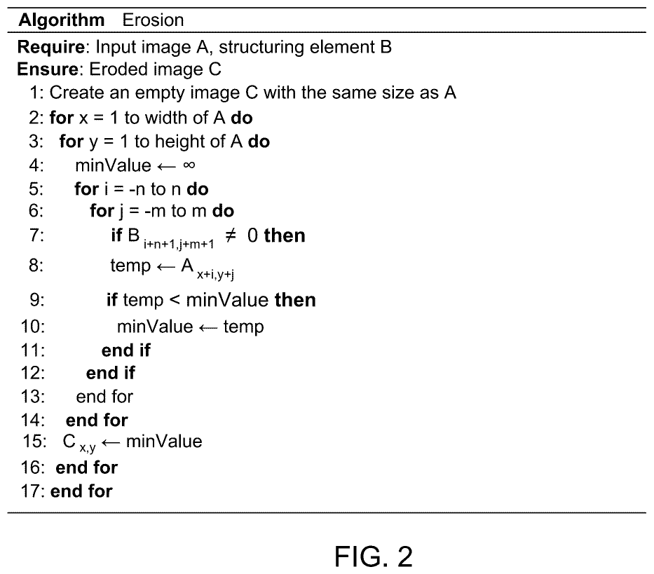

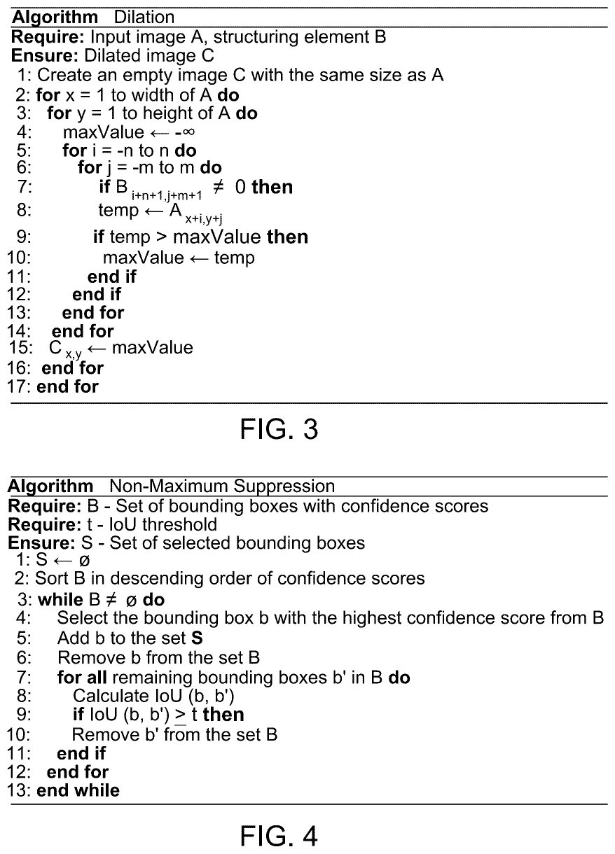

For automatic breakout detection, since the breakout regions appear to be dark in the sampled image log, the method receives in step 100 one or more image log, and then polarizes the one or more image log in step 102, by making it binary, to differentiate the dark and bright pixels, to highlight potential breakout regions. To further strengthen these regions, an erosion algorithm is applied in step 104 to make them more noticeable. The erosion algorithm, which is schematically illustrated in FIG. 2, is a technique used in image processing for removing pixels on object boundaries. In this case, the objects refer to regions where the rock exists. To automatically detect breakout regions, the method then uses contour detection in step 106 to identify the outlines of the dark regions and to pick each isolated polygon defining a dark region as a potential breakout region. After this initial detection stage, the method applies in step 108 a dilation algorithm, which is schematically illustrated in FIG. 3, and which is the reverse of the erosion algorithm. The dilation algorithm 20) eliminates the erosion effects. In step 110, a non-maximum suppression algorithm is applied to merge the overlap detections. The non-maximum suppression algorithm is schematically illustrated in FIG. 4. In step 112, tiny polygons are filtered out to exclude vugs (i.e., holes made naturally in the subsurface) and noise. A tiny polygon depends on the application based on either its height or its area, and a threshold for such polygon may be selected by the operator of the machine learning algorithm that implements the method discussed herein. In one application, a polygon is considered to be tiny if its area is smaller than 1 cm². This step may be optional. In step 114, an image having the breakout regions identified is generated and this image may be used by the operator of the drilling equipment to adjust the applied fluid pressure, or to modify the drilling parameters, or to characterize structural features within the well which are indicative of hydrocarbons in the geologic environment.

The inventors found that the method illustrated in FIG. 1 works for most of the intervals in the considered dataset. However, for intervals where the breakout has a higher proportion than the rock material, the algorithm detects the latter rather than the breakout. To improve detection performance at such intervals, the inventors implemented, in a variation of the method of FIG. 1, a depth first search algorithm in step 116, which traverses the entire image log and finds all dark regions with their size and dimensions. Then, both the results from step 116 and the results from step 110 are used as the intermediate results prior to filtering out the tiny polygons in step 112, as schematically illustrated in FIG. 1. Note that due to the nature of breakout, the combined method kept only the dark region pairs, at the same depth, with about 180-degree difference in azimuth.

The method discussed above and its variations may be restated as follow. A method for breakout detection in a well includes a step 100 of receiving image logs associated with the well, a step 102 of polarizing the image logs to distinguish between dark and bright pixels, a step 104, 106, 108, 110 of applying one or more algorithms to enhance a difference between the dark and bright pixels, and a step 114 of generating an image with breakout regions by selecting the dark pixels, wherein the image includes structural features of the well.

The method may further include a step 112 of filtering out polygons having an area smaller than a given threshold before the generating step.

The step of applying one or more algorithms includes strengthening a difference between the dark and bright pixels by applying an erosion algorithm that removes pixels on boundaries of regions of dark and bright pixels, and/or determining a contour of the regions of dark pixels by applying a contour detection algorithm and picking isolated polygons as corresponding to the regions of dark pixels, and/or eliminating erosion effect due to the strengthening step by applying a dilation algorithm, and/or merging overlapped detected polygons with a non-maximum suppression algorithm. The method may further include a step of applying a depth first search algorithm to find the dark regions when there is a higher proportion of breakout regions than rock regions.

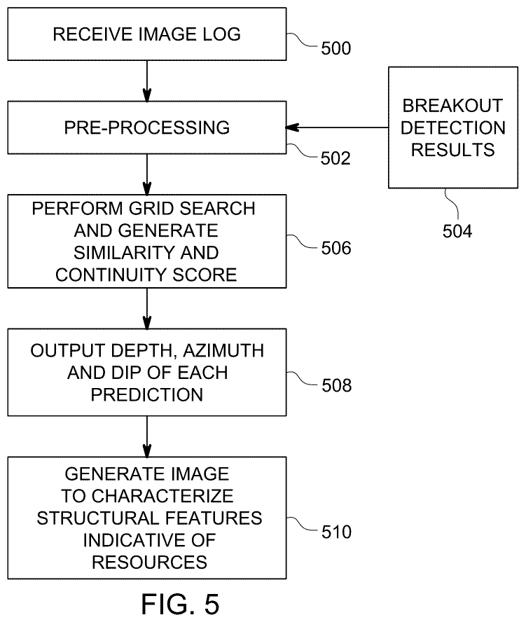

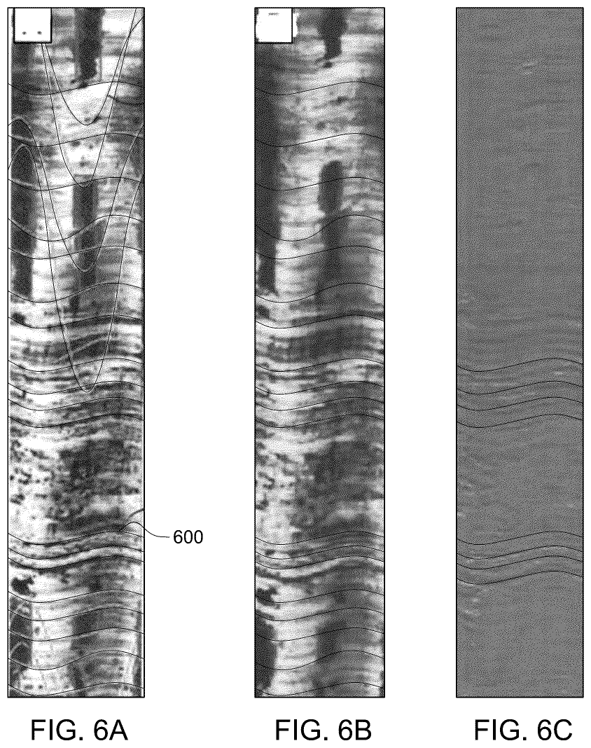

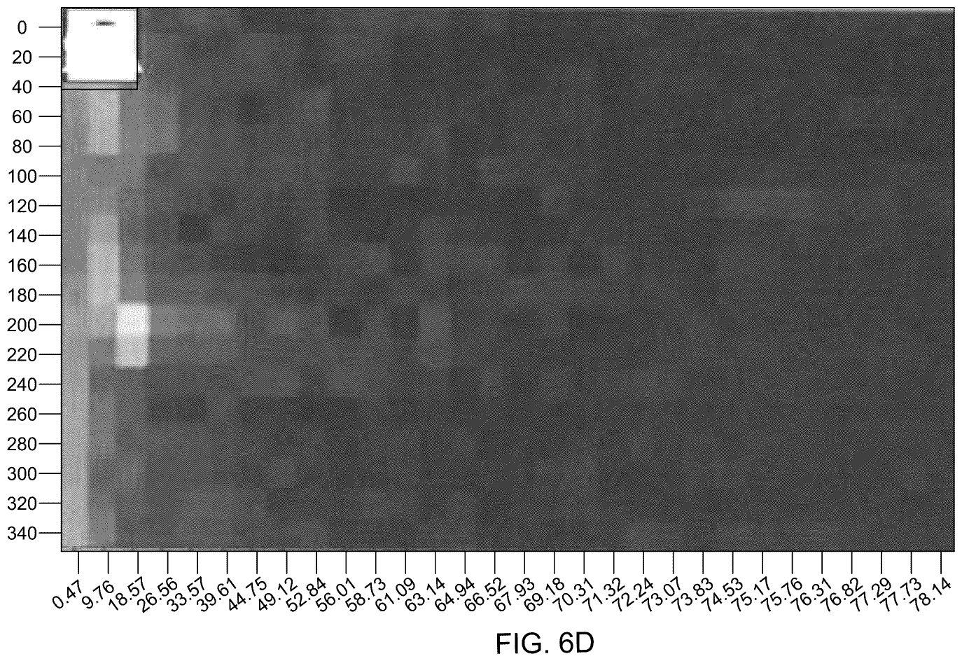

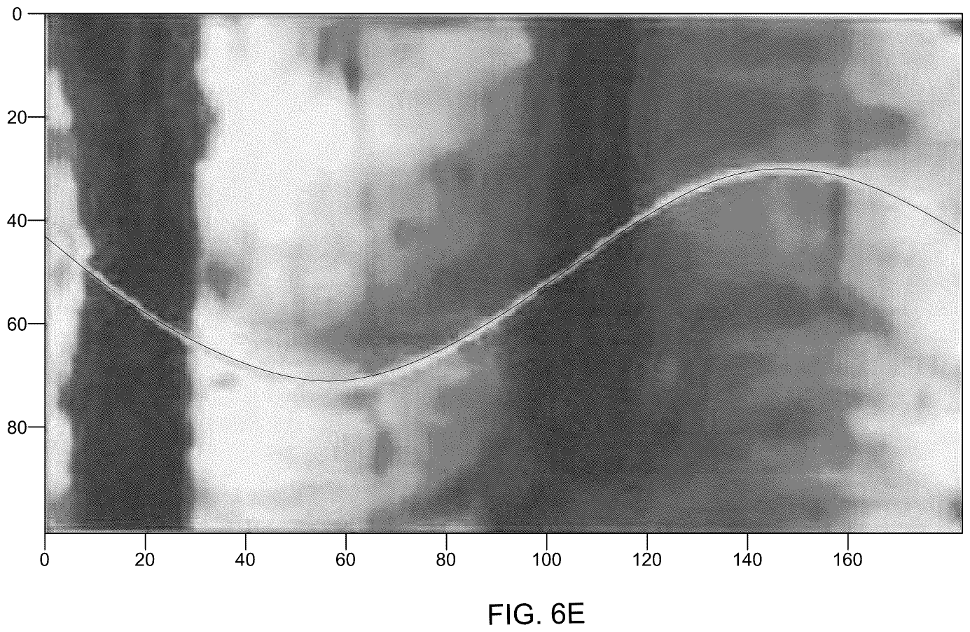

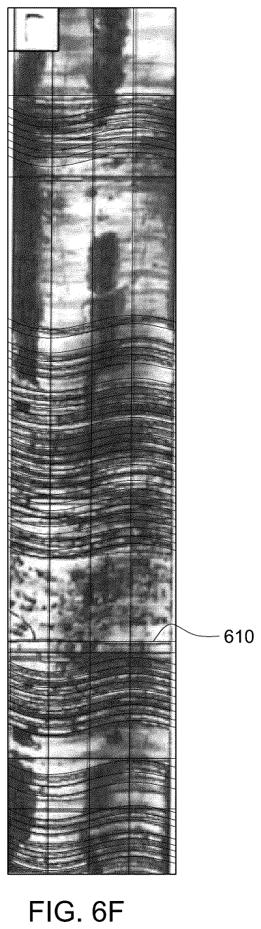

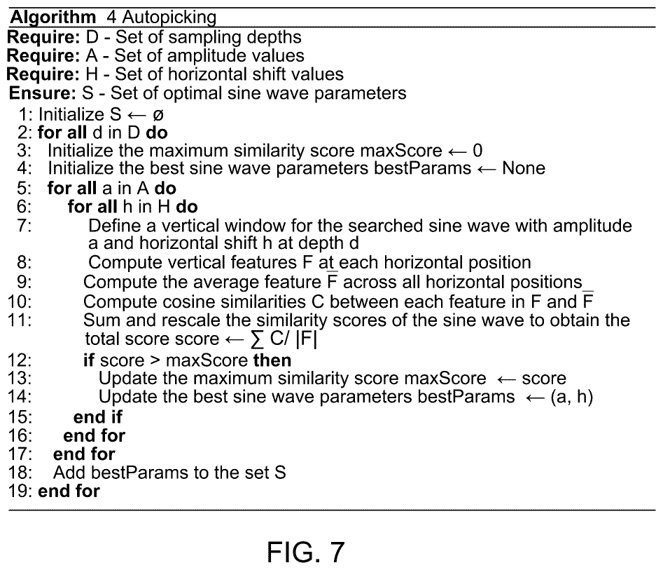

Next, the autopicking of beddings is discussed with regard to FIG. 5, which is a method that may use the same input data as the method of FIG. 1. The autopicking, which is another borehole interpretation method, is treated in this embodiment as curve fitting since beddings and fractures present in the well as sine waves, either partially or fully, and they are visible as such in the image logs. In this regard, FIG. 6A shows manual bedding picks 600 for a vertical window of about 4 m. An algorithmic approach was developed for this task that leverages the low-level image features like pixel values. Before implementing the algorithm, the input image received in step 500 in FIG. 5 (see the input image in FIG. 6B) is pre-processed in step 502 to eliminate tool marks and breakouts that make the image log noisy. The image with the tool marks and breakouts removed is shown in FIG. 6C. This step may compute the vertical gradient of the image and applies a breakout mask from the method illustrated in FIG. 1. In one implementation, the breakout mask is a binary image with 0s representing the breakout regions (calculated with the method of FIG. 1) and 1s represent the rocks. By implementing the element-wise multiplication between the input image received in step 500 and the mask calculated in step 502, based on the breakout results received in step 504, it is possible to eliminate the unnecessary content in the breakout that is irrelevant to this task. In other words, the method illustrated in FIG. 1 may be implemented in step 504 into the autopicking method of FIG. 5. Those skilled in the art would understand that one or more or all the steps of the method of FIG. 1 may be implemented in step 504. It is worth noting that this implementation uses amplitude dynamic images for autopicking and breakout marks from amplitude static images to remove breakout effects. In one application, there are static and dynamic images, and these refer to the color scale. For the dynamic image, the color absolute values change based on a set window size. For the static image, the color values are set for the entire image log. Given that the vertical amplitude and the horizontal shift of beddings vary from case to case, the method performs in step 506 a grid search on these two parameters at each sampling depth. Specifically, a vertical window is defined for each searched sine wave, giving a vertical feature, i.e., a column of pixels, at each horizontal position. Based on the fact that all vertical features should be similar for a clear pick, this step computes the cosine similarities between each vertical feature and the averaged feature across all horizontal positions, as schematically illustrated in FIGS. 6D and 6E, where FIG. 6D shows the pre-processed image and FIG. 6E shows the sine wave. FIG. 7 schematically illustrates the algorithm used for these calculations. Then, the method sums and rescales a similarity score of each searched sine wave within the range 0 to 1. After a prediction has been generated in step 506, the method computes in step 508 the azimuth and dip of the bedding based on equations (1) and (2) below. As the sine waves reflect a 3D representation of a planar surface, the computation converts the sine wave to a single azimuth and dip that reflects the maximum dip angle and orientation of the planar surface in the subsurface. The equations are given by:

$$azimuth = shift * 2 \qquad ( 1 )$$

$$dip = {tan}^{- 1} ( \frac{amplitude \times r}{width} ) , \qquad ( 2 )$$

where r is the depth resolution, i.e., how depth each pixel row represents, the “shift” represents a conversion from the feature strike azimuth to the feature dip azimuth, the “amplitude” is defined as the sine wave height measured from wave peak or trough to baseline, and the “width” is defined as the width of the borehole measured using the calliper tool. In this method, only the sine waves with similarities greater than a threshold were kept to avoid over-picking. The results of this step are shown in FIG. 6F, which shows the automatic bedding picks 610.

In addition to the similarity score, for each identified sine wave, a continuity score is generated, with continuity results are displayed in a heatmap. The continuity score reflects how continuous an identified sine wave and therefore the surface is, with a 100% continuous sine wave receiving a score that equals to the pixel width of the image. The continuity heatmap highlights where the sine wave is continuous or discontinuous. The similarity metric indicates how closely each identified feature compares to the form of a perfect sine wave. In practice, the similarity score together with the continuity score can be used to define the quality of each pick and hence used as criterion during the QC process.

Finally, in step 510, the output from step 508 is used to generate an image having the beddings identified and this image may be used by the operator of the drilling equipment to adjust the applied fluid pressure, or to modify the drilling parameters, or to characterize structural features indicative of resources in the geologic environment. The term “resources” is understood herein to mean oil and gas reservoirs, valuable minerals, geothermal resorvoirs, CO2, and any other material that is used by one or more industries.

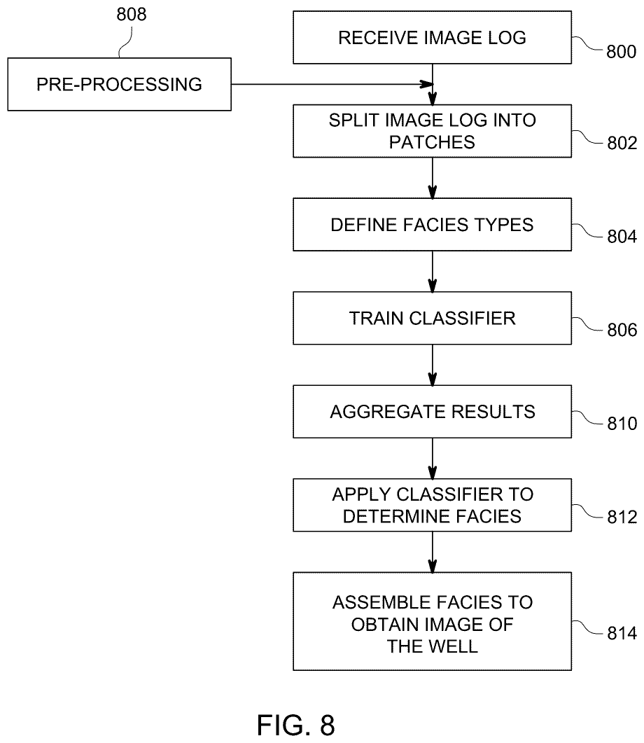

Next, a method for facies classification on image log data is discussed. The method is schematically illustrated in FIG. 8, and starts with step 800 of receiving the image log, similar to the methods discussed above with regard to FIGS. 1 and 5. In geology, a facia is a distinctive rock unit or sedimentary deposit that possesses certain physical, chemical, and/or biological characteristics that distinguish it from adjacent rock units or deposits. These characteristics may include texture, mineralogy, color, bedding, fossil content, and other features that reflect the depositional environment in which the rock was formed. In image logs, facies are typically defined by common petrophysical characteristics (e.g., slow or fast sonic response) and sedimentary structures.

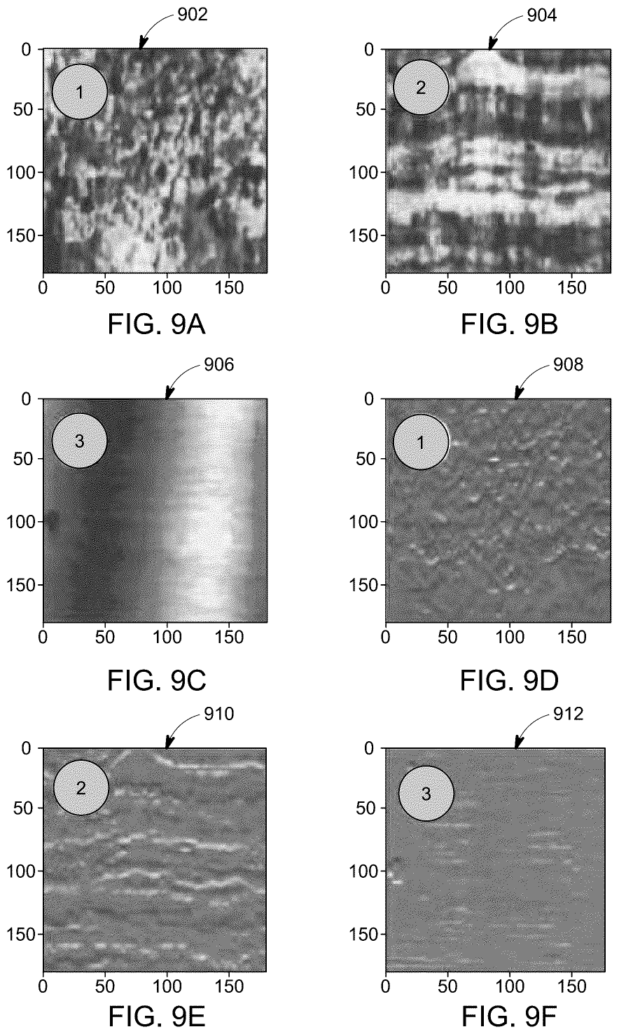

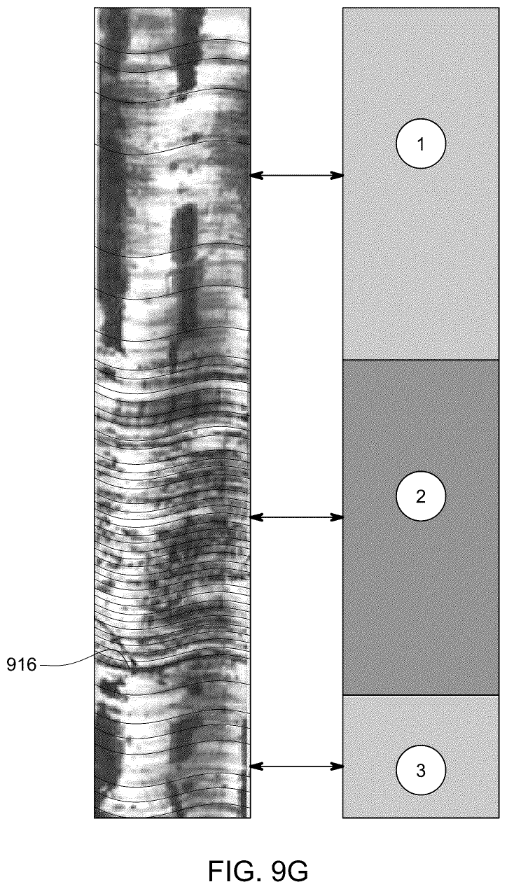

In this embodiment, the facies classification problem was treated as an image classification task. Since image logs are extremely longtall (as the length of the well is large, in the order of kms), the image logs received in step 800 were split vertically, in step 802, into patches 902, 904, 906 (see FIGS. 9A to 9C), to create reasonably sized images for the image classifier. In one application, each patch has an overlap with adjacent patches in order to generate more data, as modern image classifiers benefit from large data sizes. Regarding the facies labels, the inventors defined in step 804 four dominant facies types: vuggy, semi-laminated, laminated, and structureless. The label definition was an iterative process, and these four types are finalised based on the domain knowledge from subject matter experts, the similarity among different facies, and business values of each type. In other words, the label definition was conducted in a human-in-the-loop manner in which subject matter experts makes the image classifier more accurate and confident. Then each image patch was assigned a distinctive label. Note that in other applications, more or less facia types may be used.

Once the data and labels were generated, a convolutional neural network-based image classifier [1] or [2] was trained in step 806 to classify each patch. Before training, it is possible to apply in step 808 a pre-processing method, for example, the method used for autopicking to remove tool marks and breakouts from the input data. The results of this step are the pre-processed images 908 to 912 shown in FIGS. 9D to 9F. Data augmentation methods like random cropping and random rotation may also be used to increase the data variance. After the classification step 806, the results were aggregated in step 810, for each patch, to generate facies intervals for the entire image log.

In step 812, the trained classifier was run on image logs received in step 800 with no labels to predict facies intervals for each image log, and the predicted facies intervals were assembled in step 814 to generate a classification mask 916 over the borehole of the well, as shown in FIG. 9G. Facies 916 are visible in FIG. 9G.

Identifying breakout (as discussed in FIG. 1) is important for understanding fracture propagation, wellbore instability and regional stress trend. It is important to identify where and at what depth breakout occurs in the well. By using interpolation and contour detection, the inventors were able to accurately identify breakout and generate breakout statistics as well as a breakout mask. Through the identification of breakout, the inventors were able to improve the results of the auto-picking of bedding (see method in FIG. 5) and the prediction of image log facies (see method in FIG. 8) by removing the effects of breakout from the input image log by inverting the generated breakout mask.

While the results from the breakout detection in FIG. 1 were used in the method of FIGS. 5 and 8, there is possible to perform the methods of FIGS. 5 and 8 without any input from the method of FIG. 1. In other words, the three methods shown in FIGS. 1, 5, and 8 may be performed independent of each other, or in combination with each other, as seen fit by the operator of the well.

Automating parts of the borehole image logs (BHI) interpretation workflow has the potential to vastly improve interpretation times, accuracy and reduce interpreter bias. The inventors found that using the approach for picking bedding presented in FIG. 5, results in surface generation for an entire well in 3-5 hours, in comparison to a manual workflow which could take several days. The time for autopicking can be further reduced by leveraging parallel computing techniques. In one application, the method of FIG. 5 was tried on a 26 well dataset, which resulted in the generation of approximately 327,000 auto-picks from these wells versus 32,000 manual picks. In addition to the automatically generated surface picks, the method generated approximately 900,000 extra meta-data parameters, such as continuity score, similarity score, continuity heatmaps and outlier flags. These combined metadata provide some levels of confidence in the auto-generated picks, allowing the geoscientist to quickly determine intervals where picks are less reliable and can therefore spend more time interpreting these sections. In a manual interpretation workflow, these meta-data are either not generated or assigned in a subjective manner. While the methods discussed herein have focused on the automation of bedding picks, as these features are typically continuous sine waves, the methods may also be applied in the identification of higher angle, discontinuous features, such as fractures and faults.

In one application, automating the interpretation of image log facies took approximately 20 minutes per well, which excludes the time taken in the generation of the training data set. This automation generated facies intervals over 26 wells covering approximately 11,500 m and removed some of the subjectivity associated with manual interpretation. For each interpreted patch there is an image log facies prediction and confidence score. These are aggregated and stacked in depth order in the generation of image log facies intervals and associated confidence curves.

Borehole image log interpretation may also include lithology prediction. The term “lithology” is used in the geology field for dealing with the composition or type of rock, for example, sandstone or limestone. Lithology is relevant in the oil exploration field because is related to the permeability of the rocks and this feature indicates how fast or slow the oil will travel through the subsurface to the well.

Lithology prediction is usually done at depth-level. In this embodiment, the inventors predict lithologies at a finer pixel-level as pixel-level predictions can give a very detailed and accurate understanding of the lithology within a core image. Typically, when logging core, the geoscientist would record the details of the core at an overview scale of between 1:25 and 1:200. This means that small scale changes in lithology are not captured. Instead, a summary is typically produced and this can be somewhat subjective. By predicting lithologies at the pixel level, this means that the operator of the wellbore is able to accurately define the lithology at depth on a 1:1 scale, with much less subjectivity over that of traditional methods. Since lithologies have a strong correlation with pixel colours that can be observed from core photos, for this embodiment, the inventors decided to use Bayes' theorem as the prediction model. This approach can generate predictions at pixel-level while recent related works [3] can only generate predictions at depth-level.

Bayes' theorem is a probabilistic modelling method that can generate the prediction as well as the probability without a sophisticated training process and can achieve superior performance when there is a strong correlation between the input and the output. The Bayes' theorem [4] is formulated as

$$P ( H \vert E ) = \frac{P ( E \vert H ) \times P ( H )}{P ( E )} \qquad ( 3 )$$

where H indicates the lithology profile that the method is trying to predict, and E means the evidence on which the prediction is based. In this case, the evidence corresponds to pixel values. P(H|E) is the posterior probability and is a conditional probability, which means the probability of H given E. In this case, it is the probability of the lithology given a certain pixel value. P(E|H) is called the likelihood, i.e., how different pixel values are associated with each lithology type. P(H) is the prior probability, which is the proportion of each lithology type in the dataset, and P(E) is called marginal likelihood, which is the proportion of each pixel value. Specifically for pixel-level lithology prediction, equation (3) can be re-formulated as,

$$P ( lithology \vert pixel value ) = \frac{P ( pixel value \vert lithology ) \times P ( lithology )}{P ( pixel value )} \qquad ( 4 )$$

where P (pixel value) and P (lithology) are computed based on core photos from a sample well, and P (pixel value|lithology) is computed based on human labelling. The posterior probability is generated for each pixel. Lithology masks are then generated based on predictions at each pixel, and predictions at each depth are aggregated to generate lithology curves.

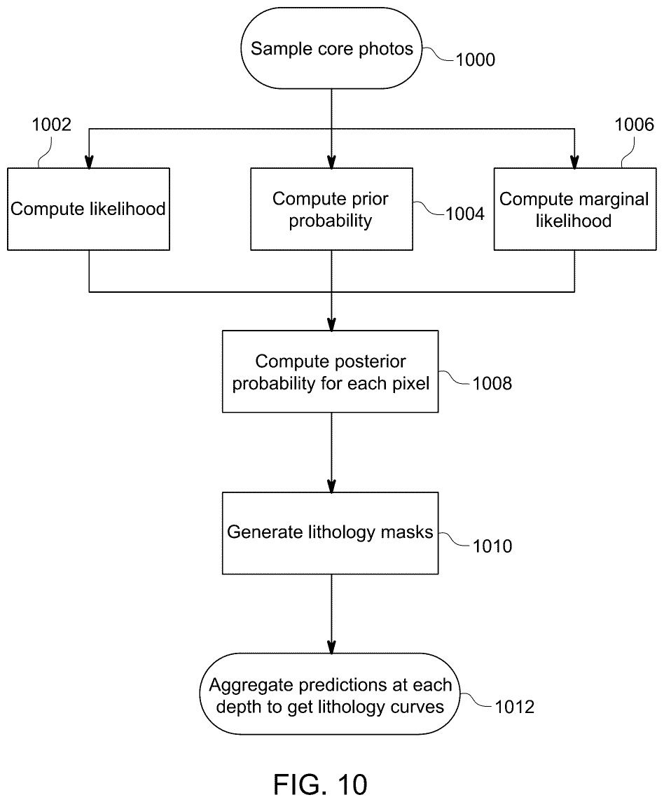

According to this embodiment, the method receives in step 1000 core images of the well, as illustrated in FIG. 10. Then, in steps 1002, 1004, and 1006, the method calculates, based on equation (4), the likelihood P(pixel value|lithology), the prior probability P(lithology), and the marginal likelihoop (pixel value) based on the pixels from the core image. In step 1008, the results from the steps 1002, 1004, and 1006 are used to calculate the posterior probability P (lithology|pixel value) for each pixel. In step 1010, lithology masks may be generated, followed by a step 1012 of aggregating the predictions at each depth to get the lithology curves. The obtained lithology curves may be used, similar to the methods of FIGS. 1, 5, and 8, during the exploration and development of petroleum reservoirs to improve oil extraction.

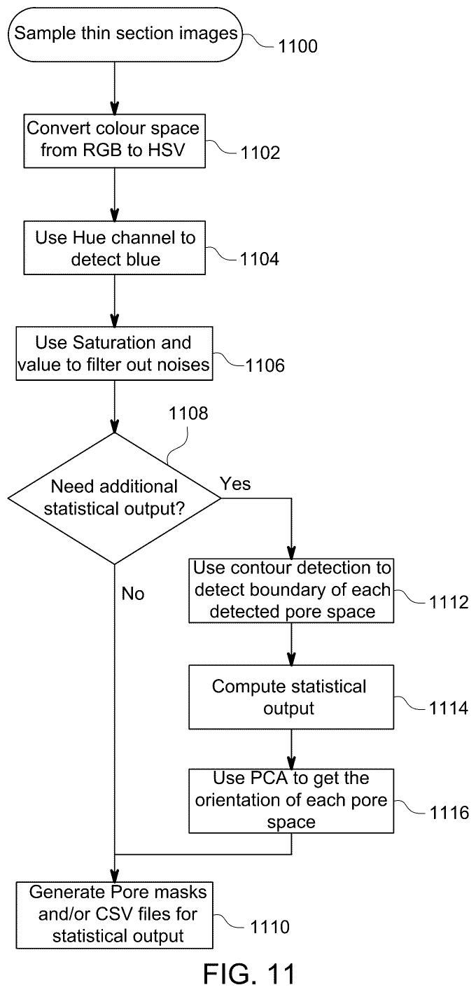

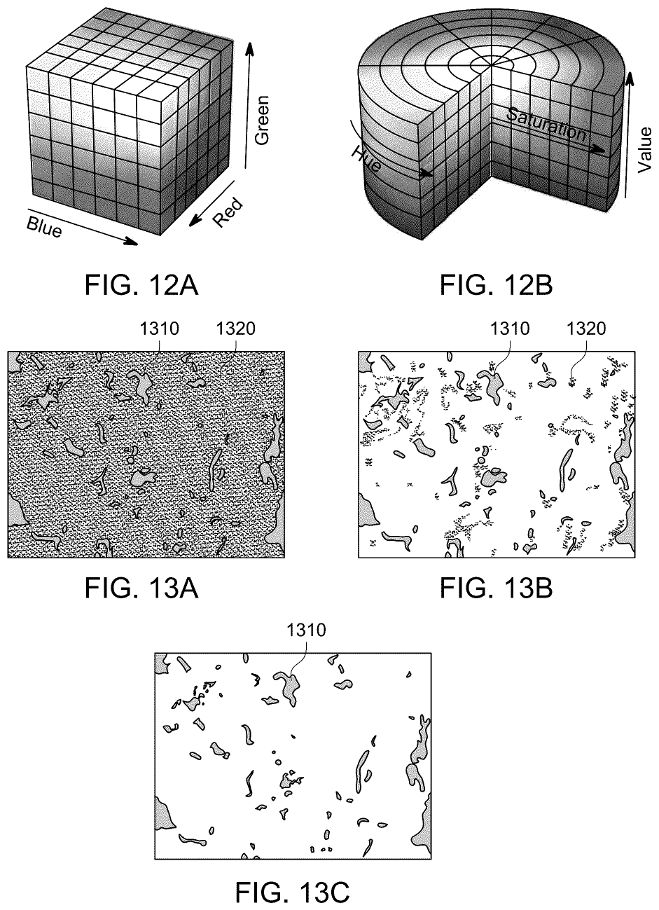

In another embodiment, the core images may be used to determine pore segmentation. An aim of this method, which is illustrated in FIG. 11, is to segment pore spaces from received thin section images in step 1100. Using a k-means clustering model, which is known in the art, the method categorizes pixels from the received core image into two clusters, pore space and background, respectively. Since pore spaces appear in blue under plain polarised light (PPL) and dark blue in crossed polarised light (XPL), the inventors decided to perform the segmentation purely based on colours. Note that the blue colour appears because of the presence of the resin in the sample, with the resin being used to hold the sample core material to a substrate when analysed with various imaging devices. Thus, the method converts in step 1102 the input thin section images from the red, green and blue (RGB) colour space to the hue, saturation, and value (HSV) colour space since the blue colour is easier to be detected in the latter space. A comparison between two colour spaces is shown in FIGS. 12A and 12B.

The method tries in step 1104 to detect blue regions 1310 by defining a Hue range. However, some grey noise points 1320 on mineral grain surfaces had also been detected, as shown in FIG. 13A. To remove noises, the method only keeps in step 1106 pixels 1310 with a value of Saturation times Value that is higher than selected threshold values (see, for example, FIGS. 13B and 13C). For example, in one implementation, the Hue range in step 1104 was set to 150 to 210 and the pixels in step 1106 were kept for a value of Saturation times Value greater than or equal to 0.2.

Additional statistical output like pore count, mean and standard deviation of pore sizes can also be generated by this method. Thus, in step 1108, the method asks the user if these additional statistical outputs are necessary. If the answer is no, the method proceeds to step 1110 to generate pore masks for the analysed images. If the answer is yes, the method proceeds to apply a contour detection in step 1112 to detect the boundary of each detected pore space. In step 1114, the method computes statistical information like the distribution of the pore angularity, location within the image, and orientation. Methods like Principal

Component Analysis (PCA) can then be used in step 1114 to get the orientation of each pore space by treating each pore space as a distribution of pixels. Specifically, for a pore space P with n pixels, P={(xₜ, yₜ)|1≤t≤n}, where (xₜ, yₜ) is the location of t-th pixel, the orientation of P, θ in radian can be calculated based on the equation below:

$$θ = {tan}^{- 1} ( \frac{\frac{{\sum }_{t = 1}^{n} {x}_{t}}{n} - {x}_{p}}{\frac{{\sum }_{t = 1}^{n} {y}_{t}}{n} - {y}_{p}} ) \qquad ( 5 )$$

where (xₚ, yₚ) is a point on the principal component of the pore space that can be calculated as,

$$( \begin{matrix}{x}_{p} \\ {y}_{p}\end{matrix} ) = ( \begin{matrix}\frac{{\sum }_{t = 1}^{n} {x}_{t}}{n} + αλ {c}_{x} \\ \frac{{\sum }_{t = 1}^{n} {y}_{t}}{n} + α λ {c}_{y}\end{matrix} ) \qquad ( 6 )$$

where (cₓ, c_{y}) is the eigenvector of the principle component and λ is the corresponding eigenvalue. α is a scale to control the distance between (xₚ, yₚ) and the central points of the pore space. These additional statistical outputs, like the pore count, and mean and standard deviation of the pore size can then be aggregated with the pore masks generated in step 1110 and can be used by the operator of the well to improve the oil extraction.

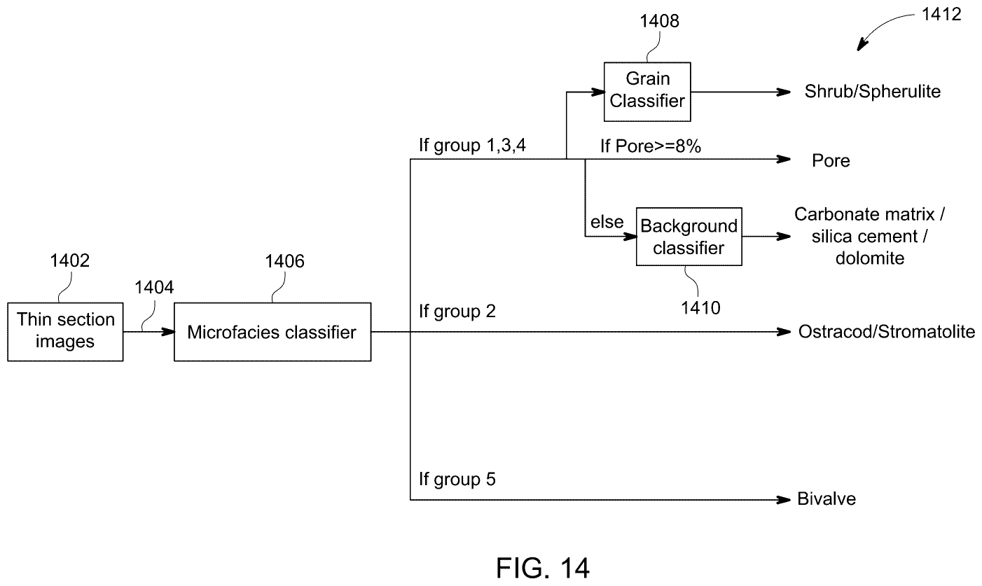

In yet another embodiment, that may be used together with any of the previous embodiments, it is possible to achieve microfacies classification on thin section images. Note that the facies detection discussed with regard to FIG. 8 was based on image log while the classification of the microfacies in this embodiment is based on optical thin images of the core material of the well. As each thin section image may have more than one microfacies types, the method splits in step 1404 each image 1402 into plural patches (for example, six) and assigns to each patch a dominant microfacies type. In one application, more or less patches may be used for splitting the image. The type of dominant microfacies may be defined by the user according to the needs for that specific well. By splitting the image into plural patches, more training data can be generated, and ambiguity in the dataset can be alleviated as each image now has only one dominant type rather than a mix of multiple types. The convolutional neural network (CNN) discussed above may be used as the image classifier for directly predicting all microfacies that can be observed in the dataset. When this approach was tried, the classification accuracy was suboptimal. To resolve this issue, the inventors grouped microfacies into five coarser groups (another number of coarser groups may be used) and trained two more image classifiers 1408 and 1410, one for grain and one for background. This embodiment also uses the porosity proportion generated in the pore segmentation embodiment of FIG. 11 to further guide the classification algorithm. FIG. 14 schematically illustrates this algorithm and how the various microfacies 1412 are determined.

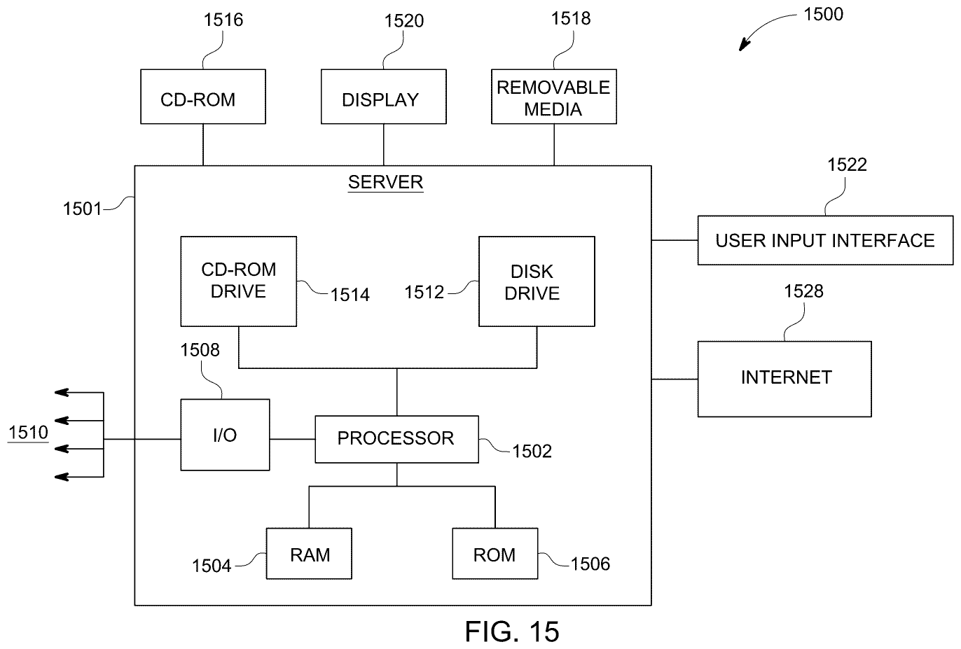

The above methods may be implemented in a system (classifier or machine learning, or neural network) as illustrated in FIG. 15. The depiction of the system 1500 is not intended to limit or otherwise confine the embodiments described and contemplated herein to any particular configuration of elements or systems, nor is it intended to exclude any alternative configurations or systems for the set of configurations and systems that can be used in connection with embodiments of the present invention. Rather, FIG. 15 and the system 1500 disclosed therein is merely presented to provide an example basis and context for the facilitation of some of the features, aspects, and uses of the methods, apparatuses, and computer program products disclosed and contemplated herein. It will be understood that while many of the aspects and components presented in FIG. 15 are shown as discrete, separate elements, other configurations may be used in connection with the methods, apparatuses, and computer programs described herein, including configurations that combine, omit, and/or add aspects and/or components.

It will be appreciated that all of the components shown in FIG. 15 may be configured to communicate over any wired or wireless communication network, including a wired or wireless local area network (LAN), personal area network (PAN), metropolitan area network (MAN), wide area network (WAN), or the like, as well as interface with any attendant hardware, software and/or firmware required to implement said networks (such as network routers and network switches, for example). For example, networks such as a cellular telephone, an 802.11, 802.16, 802.20 and/or WiMax network, as well as a public network, such as the Internet, a private network, such as an intranet, or combinations thereof, and any networking protocols now available or later developed including, but not limited to, TCP/IP based networking protocols may be used in connection with system environment and embodiments of the invention that may be implemented therein or participate therein.

Hardware, firmware, software or a combination thereof may be used to perform the various steps and operations described herein. The computing device 1500 is suitable for performing the activities described in the above embodiments and may include a server 1501. Such a server 1501 may include a central processor (CPU) 1502 coupled to a random access memory (RAM) 1504 and to a read-only memory (ROM) 1506. ROM 1506 may also be other types of storage media to store programs, such as programmable ROM (PROM), erasable PROM (EPROM), etc. Processor 1502 may communicate with other internal and external components through input/output (I/O) circuitry 1508 and bussing 1510 to provide control signals and the like. Processor 1502 carries out a variety of functions as are known in the art, as dictated by software and/or firmware instructions.

Server 1501 may also include one or more data storage devices, including hard drives 1512, CD-ROM drives 1514 and other hardware capable of reading and/or storing information, such as DVD, etc. In one embodiment, software for carrying out the above-discussed steps may be stored and distributed on a CD-ROM or DVD 1516, a USB storage device 1518 or other form of media capable of portably storing information. These storage media may be inserted into, and read by, devices such as CD-ROM drive 1514, disk drive 1512, etc. Server 1501 may be coupled to a display 1520, which may be any type of known display or presentation screen, such as LCD, plasma display, cathode ray tube (CRT), etc. A user input interface 1522 is provided, including one or more user interface mechanisms such as a mouse, keyboard, microphone, touchpad, touch screen, voice-recognition system, etc.

Server 1501 may be coupled to other devices, such as sources, detectors, etc. The server may be part of a larger network configuration as in a global area network (GAN) such as the Internet 1528, which allows ultimate connection to various landline and/or mobile computing devices.

As described above, the apparatus 1500 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 1502 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 1502 may be configured to execute instructions stored in the memory device 1504 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The methods discussed above may be performed with a deep learning machine. As used herein, the term “deep learning” refers generally to a popular machine learning method. Two main architectures associated with deep learning are applicable to addressing at least some of the particular technical challenges associated with geological environments: the convolutional neural network (“CNN”) and the recurrent neural network (“RNN”). In some instances, these deep learning architectures have proven effective in addressing technical challenges associated with geophysical interpretation.

Instead of being a pure classifier that depends on the manually-designed features such as SVM, CNN is considered to be an end-to-end wrapper classifier, at least in the sense that some CNN-based architectures are able to perform feature extraction based on the classification result and improve the performance of the machine learning model in a virtuous circle. As a complement to the capability of CNN-based architectures to capture significant features from a two-dimensional or three-dimensional matrix, RNN has the potential of refining features within the input images. In some example implementations of embodiments of the invention discussed and otherwise disclosed herein, the advantages of CNN and RNN are combined by using CNN to conduct feature extraction and dimensionality compression starting from the relevant raw image log data, and by using RNN to extract features associated with the subsurface.

In overcoming some of the technical challenges associated with predicting the proper classification of a subsurface feature, example embodiments of the invention discussed and otherwise disclosed herein address aspects of subsurface feature prediction as a classification problem with a tree structure in the label space, which can be viewed and treated as a hierarchical classification challenge. By viewing the prediction of the classification of a subsurface feature as both a multi-label classification challenge and as a multi-class classification challenge, three approaches to implementing a solution are possible: a flat classification approach, a local classifier approach, and a global classifier approach. Example implementations of embodiments of the invention disclosed and otherwise described herein reflect an advanced local classifier approach, at least in the sense that example implementations involve the construction of one classifier for each relevant internal node as part of the overall classification strategy.

The disclosed embodiments provide automated feature detection for a subsurface associated with a well, based on information obtained from the well or a surface around the well. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] Liu, Z., Mao, H., Wu, C. Y., Feichtenhofer, C., Darrell, T. and Xie, S., 2022. A convnet for the 2020s. In Proceedings of the IEEE/CVF Conference on Computer Vision and Pattern Recognition (pp. 11976-11986).
[2] LeCun, M, Bengio, Y, and Hinton, G. [2015]. Deep learning. Nature—vol 521-(436-444).
[3] Liu, W., Du, W., Guo, Y., & Li, D. [2022]. Lithology prediction method of coal-bearing reservoir based on stochastic seismic inversion and Bayesian classification: a case study on Ordos Basin. Journal of Geophysics and Engineering, 19 (3), 494-510.

[4] Webb, G., Keogh, E and Miikkulainen, Risto [2010]. Naïve Bayes. Encyclopedia of machine learning 15, 713-714.

1. A method for autopicking of bedding in a well, the method comprising:
receiving image logs associated with the well;
eliminating tool marks from the image logs;
performing a grid search for (1) a vertical amplitude and (2) a horizontal shift of the bedding at plural sampling depths to obtain a predicted bedding;
calculating an azimuth and a dip of the predicted bedding; and
generating an image of the predicted bedding, wherein the image includes structural features of the well.

2. The method of claim 1, further comprising:
receiving a breakout mask associated with the well, which is a binary image with 0s representing breakout regions and 1s representing the rocks; and
removing the breakout regions from the image log with the breakout mask.

3. The method of claim 2, wherein the step of performing comprises:
defining a vertical window for each searched sine wave, which produces a vertical feature at each horizontal position in the well; and
calculating cosine similarities between each vertical feature and an averaged feature across all horizontal positions.

4. The method of claim 3, wherein the step of performing further comprises:
summing and rescaling a similarity score of searched sine waves and generating the predicted bedding.

5. The method of claim 1, further comprising:
polarizing the image logs to distinguish between dark and bright pixels;
applying one or more algorithms to enhance a difference between the dark and bright pixels;
generating an image with breakout regions by selecting the dark pixels, wherein the image includes structural features of the well; and
removing the breakout regions from the image logs prior to the step of performing.

6. The method of claim 5, further comprising:
filtering out polygons having an area smaller than a given threshold before the generating step.

7. The method of claim 5, wherein the step of applying one or more algorithms comprises:
strengthening a difference between the dark and bright pixels by applying an erosion algorithm that removes pixels on boundaries of regions of dark and bright pixels.

8. The method of claim 7, wherein the step of applying one or more algorithms comprises:
determining a contour of the regions of dark pixels by applying a contour detection algorithm and picking isolated polygons as corresponding to the regions of dark pixels.

9. The method of claim 8, wherein the step of applying one or more algorithms comprises:
eliminating erosion effect due to the strengthening step by applying a dilation algorithm.

10. The method of claim 9, wherein the step of applying one or more algorithms comprises:
merging overlapped detected polygons with a non-maximum suppression algorithm.

11. The method of claim 10, further comprising:
applying a depth first search algorithm to find the dark regions when there is a higher proportion of breakout regions than rock regions.

12. The method of claim 10, wherein the dark pixels calculated with the steps of strengthening, determining, eliminating, and merging are selected for the image with breakout regions.

13. A method for facies classification based on image logs associated with a log, the method comprising:
receiving image logs associated with the well;
splitting the image logs into plural patches;
implementing a trained classifier to determine the facies corresponding to the plural patches; and
assembling the facies to obtain an image of the well, wherein the image includes structural features of the well.

14. The method of claim 13, further comprising:
defining facies types and associating the patches with one of the facies;
receiving breakouts regions of the well and removing tool marks and the breakout regions from the patches to obtained pre-processed data.

15. The method of claim 14, further comprising:
training a classifier based on the pre-processed data to obtain the trained classifier.

16. The method of claim 13, further comprising:
defining facies labels as being vuggy, semi-laminated, laminated, and structureless and training the classifier to determine these labels.

17. The method of claim 13, further comprising:
polarizing the image logs to distinguish between dark and bright pixels;
applying one or more algorithms to enhance a difference between the dark and bright pixels;
generating an image with breakout regions by selecting the dark pixels, wherein the image includes structural features of the well; and
removing the breakout regions from the image logs prior to the step of splitting.

18. The method of claim 17, wherein the step of applying one or more algorithms comprises:
strengthening the difference between the dark and bright pixels by applying an erosion algorithm that removes pixels on boundaries of regions of dark and bright pixels; and
determining a contour of the regions of dark pixels by applying a contour detection algorithm and picking isolated polygons as corresponding to the regions of dark pixels.

19. The method of claim 18, wherein the step of applying one or more algorithms comprises:
eliminating erosion effect due to the strengthening step by applying a dilation algorithm.

20. The method of claim 19, wherein the step of applying one or more algorithms comprises:
merging overlapped detected polygons with a non-maximum suppression algorithm.
